(19) United States
(12) Patent Application Publication
(10) Pub. No.: US 2009/0044184 A1
(43) Pub. Date: Feb. 12, 2009

(54) Software update from off air broadcast

(76) Inventors: Peter G. Panagas, JR., Santa Clara, CA (US); Jean-Marc A. Laurent, Santa Clara, CA (US)

Correspondence Address: CHRISTOPHER P MAIORANA, PC;LSI Corporation, 24840 HARPER, SUITE 100, ST CLAIR SHORES, MI, 48080, US

(21) Appl. No.: 11/835,780

(22) Filed: Aug. 8, 2007

(51) Int. Cl. G06F 9/44

(52) U.S. Cl. 717/173

(57) ABSTRACT

The present invention concerns a system comprising a server, a digital recorder, a memory, an optical disc and a drive. The server may be configured to broadcast a software update through an off air network. The digital recorder may be configured to receive an off air download and download the software update. The memory may be configured to store the software update. The drive may be mounted in the digital recorder. The drive may be configured to write the software update from the memory to a writable optical disc. The digital recorder may be upgraded with the software update from the writable optical disc.

### FIELD OF THE INVENTION

The present invention relates to software updates generally and, more particularly, to a system and/or method for implementing a set top box software update from an off air broadcast.

### BACKGROUND OF THE INVENTION

Conventional software field upgrades are used by many manufacturers of consumer electronic equipment. A typical upgrade involves downloading a new version of the software to use for the upgrade. A registration on the Internet is often needed before such a download. After downloading, the software is then written to a disc in a format somewhat equipment specific. The software on the disc is then used to write the code into a flash memory on the system. In DVD players and recorders, this process is fairly easy because a disc can be inserted in the tray to start the upgrade. The most advanced upgrade techniques are power safe. If the upgrade fails, the system will fall back to a state where the system can try to upgrade the code again until the upgrade is successful.

It would be desirable to implement a system to upgrade DVD-recorder software in the field with zero (or minimal) impact on the cost of the final product.

### SUMMARY OF THE INVENTION

The present invention concerns a system comprising a server, a digital recorder, a memory, an optical disc and a drive. The server may be configured to broadcast a software update through an off air network. The digital recorder may be configured to receive an off air download and download the software update. The memory may be configured to store the software update. The drive may be mounted in the digital recorder. The drive may be configured to write the software update from the memory to a writable optical disc. The digital recorder may be upgraded with the software update from the writable optical disc.

The objects, features and advantages of the present invention include providing a system and/or method that may (i) allow a safe upgrade of new generation DVD-recorders with digital broadcast decode support, (ii) remove the need for a second flash memory or hard disc drive, (iii) remove the need for an Internet connection, (iv) be implemented with very limited user intervention, (v) be implemented with low maintenance from the manufacturer and/or (vi) be implemented so a manufacturer may insure that a wide base of systems in the field have the latest code.

### BRIEF DESCRIPTION OF THE DRAWINGS

These and other objects, features and advantages of the present invention will be apparent from the following detailed description and the appended claims and drawings in which:

FIG. 1 is a block diagram of a digital set-top box receiving an off air safe download and updating;

FIG. 2 is a block diagram of a web downloaded update burned to disc and upgraded in DVD player;

FIG. 3 is a block diagram of the combined techniques of the set-top box update and the web downloaded update; and

FIG. 4 is a flow diagram illustrating a method for updating a digital recorder.

### DETAILED DESCRIPTION OF THE PREFERRED EMBODIMENTS

With the emergence of Free to Air digital Broadcast (e.g., Europe DVB-T and USA ATSC) the demand for DVD-recorders able to record digital broadcast is growing. While such a system normally broadcasts programming, additional broadcasts may also be implemented. For example, program guide information may be implemented. Such guide information may be useful to a set-top box recorder to provide a graphical interface to initiate recordings. Information useful to a viewer, such as which actors are in a particular show, which episode is being broadcast, whether a program is a repeat, etc. may also be broadcast. While such broadcasts are useful, additional broadcasts may also be implemented. For example, a software update for a STB may be sent over such a broadcast. Since such broadcasts are sometimes subject to interruptions and/or dropouts, safeguards may need to be implemented to ensure a STB is properly upgraded.

One upgrade technique may be to broadcast the software (e.g., code) and save the code into a flash memory of the system, and then run a code to upgrade the system Flash with the new code. Such an implementation may be capable of recovering from an upgrade failure. For example, if the upgrade fails, there is always one of the two Flash memories that stays intact. Such an implementation is normally power safe. However, such a system would need to implement two flash memories (e.g., doubling the cost of to record digital broadcast is growing. While such a system normally broadcasts programming, additional broadcasts may also be implemented. For example, program guide information may be implemented. Such guide information may be useful to a set-top box recorder to provide a graphical interface to initiate recordings. Information useful to a viewer, such as which actors are in a particular show, which episode is being broadcast, whether a program is a repeat, etc. may also be broadcast. While such broadcasts are useful, additional broadcasts may also be implemented. For example, a software update for a STB may be sent over such a broadcast. Since such broadcasts are sometimes subject to interruptions and/or dropouts, safeguards may need to be implemented to ensure a STB is properly upgraded.

One upgrade technique may be to broadcast the software (e.g., code), save the code into a flash memory of the system, and then run a code to upgrade the system Flash with the new code. Such an implementation may be capable of recovering from an upgrade failure. For example, if the upgrade fails, there is always one of the two Flash memories that stays intact. Such an implementation is normally power safe. However, such a system would need to implement two flash memories (e.g., doubling the cost of implementing a single flash memory), which impacts the overall price of the STB.

The present invention may provide a variety of safeguards when updating the code (e.g., software or firmware) of a set-top box using an off air broadcast. The present invention may use the storage available in the STB (e.g., an optical disc in the DVD-recorder) to optimize material costs of the end product. The present invention may provide a system and/or method to upgrade a set-top box that may ensure the system is either upgraded without errors or the upgrade is delayed.

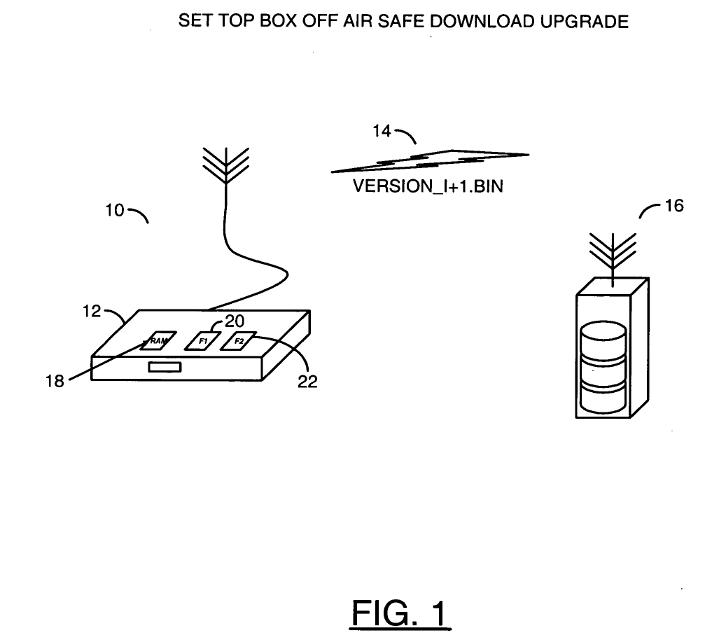

Referring to FIG. 1, a block diagram of a system 10 is shown. The system 10 illustrates one example of an off air safe download upgrade. The system 10 generally comprises a set-top box 12, an off air network 14 and a server 16. The set-top box 12 generally comprises a memory 18, a memory 20, and a memory 22. The memory 18 may be implemented as a random access memory (RAM). The memory 20 may be implemented as a flash memory. The memory 22 may be implemented as a flash memory. The memory 18 may be running a current code (e.g., VERSION_i.BIN). The memory 20 may be running a current code. The memory 22 may download a software update embedded with the latest (e.g., newer) code version (e.g., VERSION_i+1.BIN). The memory 20 may be upgraded by the memory 22 with the latest code version. The server 16 may be implemented as a digital television server. The server 16 may be configured to periodically broadcast the latest code version (e.g., once ever twenty-four hours). The off air network 14 may carry the software update in a format available for downloading.

In one example, the server 16 may broadcast the latest binary code for a particular set-top box 12. The code may be broadcasted over the off air network 14. An identification header may be included with the code to identify a particular model of set-top box to be upgraded. If the set-top box recognizes the code as a match, the set-top box 12 may receive and download the updated code. The upgrade may be stored in the memory 18 of the set-top box 12. The updated code may then be written to one of either the flash memory 20 or the flash memory 22. For example, the flash memory 20 may store the updated code. The set-top box 12 may then attempt to update the flash memory 22. The update process may be repeated until a successful verification has occurred. If a successful upgrade is not completed within a certain number of attempts, the process may be halted. A halted upgrade attempt may indicate either a corrupted code download, or an otherwise non-usable code. In the case of a non-usable download of new code, the set-top box 12 normally continues to operate using the existing code.

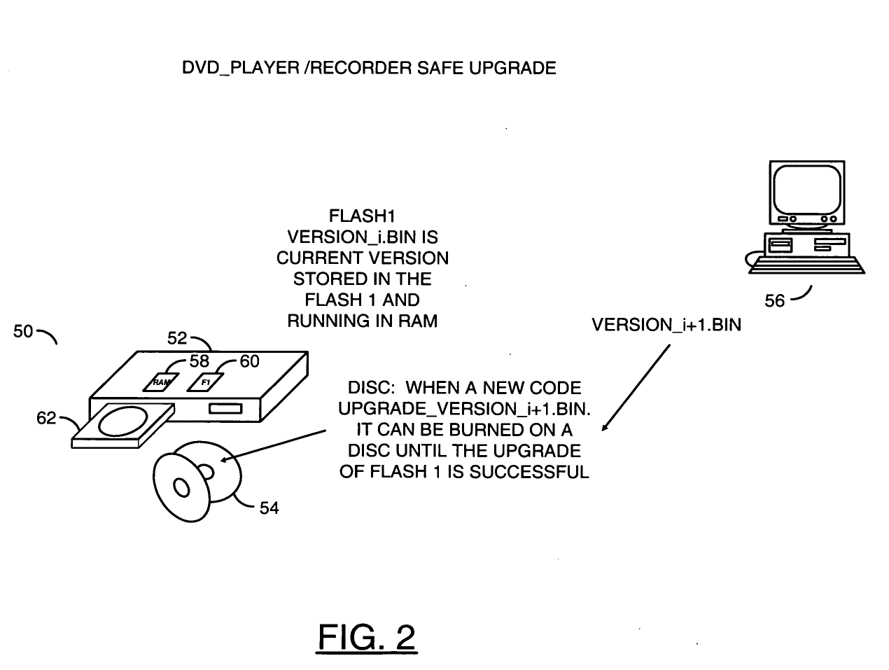

Referring to FIG. 2, a block diagram of a system 50 is shown. The system 50 illustrates an upgrade through an Internet download. The system 50 generally comprises a set-top box (or player) 52, a disc 54 and a computer 56. The player 52 generally comprises a memory 58, a memory 60, and a drive 62. The player 52 may be implemented as a DVD player. The memory 58 may be implemented as a random access memory (RAM). The memory 60 may be implemented as a flash memory. The computer 56 may be able to access the Internet. The computer 56 may download the software update with the latest code version (e.g., VERSION_i+1.BIN). The computer 56 may write the latest code version to the disc 54. The drive 62 may be used to read the disc 54. The memory 58 may by configured to upgrade the memory 60 with the latest code version from the disc 54. The memory 58 may try to upgrade the memory 60 until a successful upgrade has been confirmed. An upgrade may be attempted as long as the memory 60 has a current code (e.g., VERSION_i.BIN) running.

For example, an update for the player 52 (e.g., a DVD player) may be downloaded from the Internet. The update may then be written to the optical disc 54 using the computer 56. A user may then remove the disc 56 from the computer 56 and insert the disc 54 into the player 52. The player 52 may then update the current software with updated software.

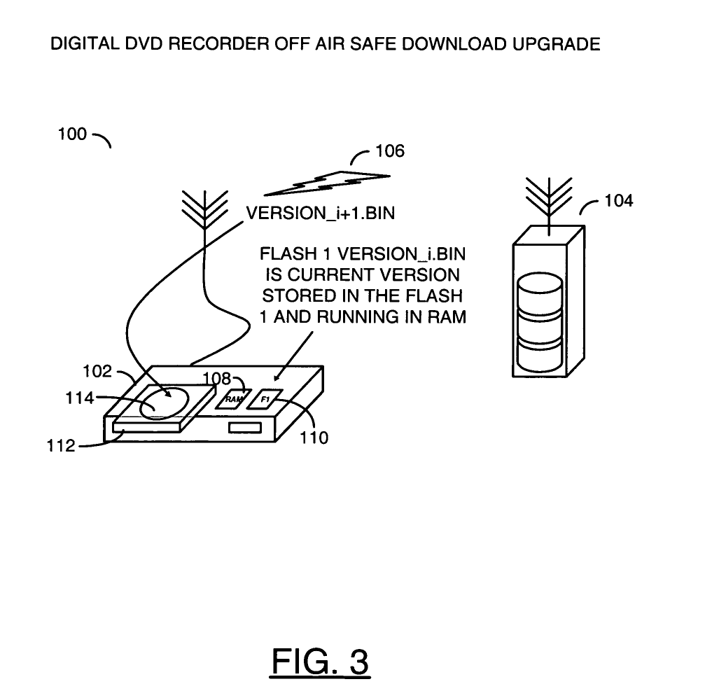

Referring to FIG. 3, a block diagram of a system 100 is shown. The system 100 generally comprises a recorder 102, a server 104 and an off air network 106. The recorder 102 generally comprises a memory 108, a memory 110, a drive 112 and a disc 114. The memory 108 may be implemented as random access memory (RAM). The memory 110 may be implemented as a flash memory. The disc 114 may be implemented as an optical disc. The drive 112 may be configured to read/write to the optical disc 114. The disc 114 may be written on by the drive 112. The server 104 may be implemented as a digital television server. The sever 104 may periodically broadcast (e.g., once every twenty-four hours) the software update embedded with the latest code version (e.g., VERSION_i+1.BIN). The off air network 106 may carry the latest software update. The memory 108 may download the software update embedded with the latest code version from the off air network 106. The drive 112 may write the latest code version from the memory 108 to the disc 114. The memory 108 may then upgrade the memory 110 with the latest code version from the optical disc 114.

In one example, when an upgraded code version (e.g., VERSION_i+1.BIN) is received, the upgraded code may be automatically written to the disc 114. The optical disc 114 may then safely store the upgraded code. The recorder 102 may then attempt to update the flash memory 110 with the new code stored on the disc 114. The memory 108 may detect that the optical disc 114 has the new code and may attempt to upgrade the memory 110 with the new code. The memory 108 may continually attempt to upgrade the flash memory 110 until a successful upgrade has been confirmed.

Referring to FIG. 4, a flow diagram illustrating a method 200 is shown. The method 200 generally comprises a state 202, a state 204, a state 206, a state 208, a state 210, a decision state 212, a state 214, and a state 216. The state 202 may insert the optical disc 114 into the recorder 102. The state 204 may receive the updated code. The state 206 may download the updated code to a memory (e.g., the memory 108). The state 208 may write the updated code to a disc (e.g., the disc 114). The state 210 may update a memory (e.g., the re-writable memory 110) with the updated code. The decision state 212 may check for a complete and confirmed update of the memory 110 from the optical disc 114. If the update has been confirmed, the method 200 moves to the state 216. If not, the method 200 moves to the state 214. The state 214 may repeat until the re-writable memory 110 has been successfully updated.

The digital recorder 102 updates the current code from the optical disc 114. The latest code version may be downloaded from an off air network 106. The server 104 is generally configured to broadcast a software update through the off air network 106. In one example, the server 104 may be a digital television server. Typically, the server 104 may broadcast the latest software update once every twenty-four hours. For example, a digital recorder running VERSION_i may download the latest version, VERSION_i+1, broadcasted by the server 104.

The digital recorder 102 is generally configured to be able to receive Off the Air Downloads (OAD). Typically, the digital recorder 102 may download software updates from the server 104. The digital recorder 102 may be configured to have a memory where the software updates may be temporarily stored. The downloaded software update from the off air broadcast may be stored on the memory 110 until being successfully written to the optical disc 114.

The digital recorder 102 may have a drive 112 mounted inside that is generally configured to write to an optical disc 114. The owner of the recorder 102 may provide a writable optical disc 114 that may be used to store the software update. The memory 110, where the downloaded software update is temporarily stored, may attempt to write the software update to an optical disc 114. If the software update is successfully written to the optical disc 114, then the optical disc 114 may try to update the Flash memory 110 with the newest software version.

If the software update is successfully downloaded and written to the optical disc 114, the optical disc 114 may then attempt to update the internal Flash memory 110 of the digital recorder 102. The optical disc 114 may continually attempt to update the Flash memory 110 of the digital recorder 102 until the update is verified. The digital recorder 102 may continually repeat the process to make sure that the newest available software update is the current running software on the digital recorder 102. This may allow the digital recorder 102 to have the newest software running provided by the server 104.

The present invention may be useful in a market that has shown a real interest for implementing off the air downloads. Off air downloads are more discrete to the user than conventional CD upgrade and do not need a web based server. The present invention may be useful in set-top boxes that use off air downloads, without the overhead of implementing two flash memories for safe upgrades.

The present invention may use the recordable space on an optical disc in a DVD-recoder to save the downloaded file. Using the optical disc saves the need to implement a costly additional Flash memory.

The function performed by the flow diagram of FIG. 4 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs, or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, magneto-optical disks, ROMS, RAMS, EPROMs, EEPROMS, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the scope of the invention.

1. A system comprising:
a server configured to broadcast a software update through an off air network;
a digital recorder configured to receive an off air download of said software update;
a memory configured to store said software update; and
a drive mounted in said digital recorder and configured to write said software update from said memory to a writable optical disc, wherein said digital recorder is upgraded with said software update from said writable optical disc.

2. The system according to claim 1, wherein said server comprises a digital television server.

3. The system according to claim 1, wherein said drive comprises a writable optical drive.

4. The system according to claim 1, wherein said memory comprises a random access memory.

5. The system according to claim 1, wherein said drive comprises a writable DVD drive.

6. The system according to claim 1, wherein a re-writable memory is upgraded with said software update from said writable optical disc.

7. The system according to claim 6, wherein said re-writable memory comprises a Flash.

8. The system according to claim 1, wherein said writable optical disc is selected from the group consisting of DVD-R, DVD+R, DVD-RW, DVD+RW, CD-R, CD-RW, BD-R, BD-RE, HD DVD-R, HD DVD-RAM.

9. The system according to claim 1, wherein said digital recorder comprises a digital DVD-recorder.

10. A method for updating software in a digital recorder, comprising the steps of:
(A) inserting a writable optical disc into a drive mounted in a digital recorder;
(B) receiving a software update from an off air download broadcasted by a server;
(C) downloading said software update to a memory of said digital recorder;
(D) using said drive to write said software update to said writable optical disc from said memory; and
(E) upgrading a re-writable memory with said software update from said writable optical disc.

11. The method according to claim 10, wherein step (A) further comprises turning off said digital recorder.

12. The method according to claim 10, wherein said memory comprises a random access memory.

13. The method according to claim 10, wherein said re-writable memory comprises a Flash memory.

14. The method according to claim 10, wherein said server comprises a digital television server.

15. The method according to claim 10, wherein said digital recorder comprises a digital DVD-recorder.

16. The method according to claim 10, wherein said writable optical disc is selected from the group consisting of DVD-R, DVD+R, DVD-RW, DVD+RW, CD-R, CD-RW, BD-R, BD-RE, HD DVD-R, HD DVD-RAM.

17. The method according to claim 10, wherein said method further comprises (F) repeating (A)-(E) when a new software update is broadcast.

18. The method according to claim 10, wherein step (E) further comprises repeating until said re-writable memory is updated.

19. The method according to claim 10, wherein said software comprises firmware.
